(19) United States
(12) Patent Application Publication
(10) Pub. No.: US 2004/0021663 A1
(43) Pub. Date: Feb. 5, 2004

(54) Information processing method for designating an arbitrary point within a three-dimensional space

(76) Inventors: Akira Suzuki, Tokyo (JP); Shigeru Enomoto, Tokyo (JP)

Correspondence Address: KATTEN MUCHIN ZAVIS ROSENMAN, 575 MADISON AVENUE, NEW YORK, NY, 10022-2585, US

(21) Appl. No.: 10/460,745

(22) Filed: Jun. 11, 2003

(30) Foreign Application Priority Data
Jun. 11, 2002 (JP) 2002-170184
Mar. 26, 2003 (JP) 2003-084103

(51) Int. Cl. G06T 15/00

(52) U.S. Cl. 345/419

(57) ABSTRACT

A three dimensional space is displayed on a two-dimensional display screen, a coordinate value, and a pressing force value of the point within the two-dimensional display screen designated by a user are detected, and a position within the three-dimensional space is specified according to the coordinate value and passing force value. This means it is possible for a user to easily designate an arbitrary point within a three-dimensional space by designating a point on a two-dimensional display screen. Namely, it is possible to easily designate an arbitrary point within a three-dimensional space by natural operation that is close to the operation in the real world with high accuracy.

This application is related to Japanese Patent Application No. No. 2002-170184 filed on Jun. 11, 2002, and No. 2003-94103 filed on Mar. 26, 2003, based on which this application claims priority under the Paris Convention and the contents of which are incorporated herein by reference.

### BACKGROUND OF THE INVENTION

1. Field of the Invention

The present invention relates to an information processing method, a computer readable recording medium having recorded therein an information processing program, an information processing program, and an information processing device, all of which are suitable for designating an arbitrary point within a three-dimensional space displayed on a two-dimensional display screen.

2. Description of the Related Art

Conventionally, users have designated a desired point to a system through input devices, such as a mouse pointer, a tablet, and a touch panel or with a finger when designating an arbitrary point within an image displayed on a two dimensional display screen.

However, since the configuration of conventional systems only allow designations of a point position within a two-dimensional display screen, it is impossible to, for example, designate an arbitrary point within a three-dimensional space displayed on a two-dimensional display screen.

It should be noted that designation of an arbitrary point in a three-dimensional space is possible by using other input devices for designating a point position in vertical direction (depth direction) (z) to a display screen in addition to a input device for designating a point position (x, y) within a display screen or by directly inputting three-dimensional coordinate values (x, y, z) of the point to designate. However, if these approaches are taken, operation by a user becomes extremely complicated and a point will not be designated easily.

In addition, designating a point position witin a three-dimensional space is also possible by using a three-dimensional mouse pointer for example. However, since typical three-dimensional mouse pointers are configured to be operated by a user in the air, a lot of effort is needed for a user to designate a point and it is difficult to designate a point correctly to a system.

### SUMMARY OF THE INVENTION

The present invention was achieved to solve the above problems and the object of the present invention is to provide an information processing method, a computer readable recording medium having recorded therein an information processing program, an information processing program, and an information processing device, all of which are for enabling designation of an arbitrary point in a three-dimensional space displayed on a two-dimensional display screen with easy and natural operation and with high accuracy.

The first aspect of the present invention consists in displaying a three-dimensional space on a two-dimensional display screen, detecting coordinate values and a depth value of a point within a two-dimensional display screen designated by a user, and specifying the position within the three-dimensional space according to the coordinate values and the depth value. Namely, in the present invention, a position within a three-dimensional space designated by a user is specified based on a point position and a depth value at the position on a two-dimensional display screen designated by a user. According to this configuration, users can designate easily and with high accuracy point within a three-dimensional space with operation that is natural and close to the real movement.

The second aspect of the present invention consists in displaying at least one object on a two-dimensional display screen, detecting coordinate values and a depth value of a point on a two-dimensional display scrcen designated by a user, and executing processing to an object designated by the coordinate values to the depth value. Namely, in the present invention a predetermined operation is executed to an object that exists on the point designated by a user according to a depth value. According to this configuration, even users who are not used to operating devices can operate an object displayed within a two-dimensional display screen easily and naturally.

Other and further objects and features of the present invention will become obvious upon understanding of the illustrative embodiments about to described in connection with the accompanying drawings or will be indicated in the appended claims, and various advantages not referred to herein will occur to one skilled in the art upon employing the invention in practice.

### BRIEF DESCRIPTION OF THE DRAWINGS

FIG. 1 is a block diagram for illustrating a configuration of an information processing apparatus according to the first embodiment of the present invention;

FIG. 2 is a schematic diagram for illustrating a configuration of an operation input section according to the first embodiment of the present invention;

FIG. 3 is a schematic diagram for illustrating an exemplary application of the operation input section shown in FIG. 2;

FIG. 4 is a schematic diagram for illustrating connections between pressure-sensitive elements and electric wiring shown in FIG. 2;

FIG. 5 is a flow chart for illustrating a method of designating three-dimensional coordinate values according to the embodiment of the present invention;

FIG. 6 is a schematic diagram for describing the method of designating three-dimensional coordinate values shown in FIG. 5

FIG. 7 is a schematic diagram for describing an exemplary application of the method of designating three-dimensional coordinate values shown in FIG. 6;

FIG. 8 is a schematic diagram for describing an exemplary usage of method of designating three-dimensional coordinate values shown in FIG. 5;

FIG. 9 is a schematic diagram for describing an exemplary usage of the method of designating three-dimensional coordinate values shown in FlG 5;

FIG. 10 is a schematic diagram for describing an exemplary usage of the method of designating three-dimensional coordinate values shown in FIG. 5;

FIG. 11 is a schematic diagram for describing an exemplary usage of the method of designating three-dimensional coordinate values shown in FIG. 5;

FIG. 12 is a schematic diagram for describing an exemplary usage of the method of designating three-dimensional coordinate values shown in FIG. 5;

FIG. 13 is a flowchart for illustrating a method of operating an icon according to the embodiment of the present invention;

FIG. 14 is a schematic view for illustrating the configuration of an operation input section according to the second embodiment of the present invention;

FIG. 15 is a schematic view for illustrating an exemplary application of the operation input section shown in FIG. 14;

FIG. 16 is a schematic view illustrating an exemplary application of the operation input section shown in FIG. 14;

FIG. 17 is a schematic view illustrating an exemplary application of the operation input section shown in FIG. 14:

FIG. 18 is a flow chart for describing operation of an information processing apparatus according to the second embodiment of the present invention;

FIG. 19 is a schematic view illustrating an exemplary application of the operation input section according to the embodiment of the present invention;

FIG. 20 is a schematic view illustrating an exemplary application of the operation input section according to the embodiment of the present invention; and

FIG. 21 is a schematic view illustrating an exemplary application of the operation input section according to the embodiment of the present invention.

### DETAILED DESCRIPTION OF THE PREFERRED EMBODIMENT

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

An information processing apparatus according to the present invention can be applied to processing for making a device execute a predetermined processing, by designating and operating an arbitrary point within a three-dimensional space displayed on a two-dimensional display screen. In the following, the configuration and the operation of the information processing apparatus according to the first and the second embodiment of the present invention is described.

### First Embodiment

Configuration of an Information Processing Apparatus

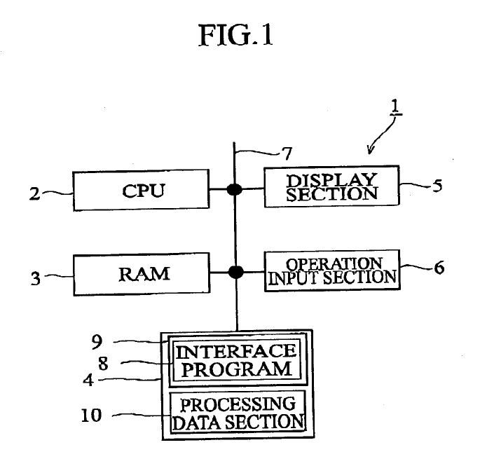

As shown in FIG. 1, an information processing apparatus 1 according to first embodiment of the present invention comprises CPU 2, RAM 3, ROM 4, a display section 5, and an operation input section 6, all of which are connected with each other electrically through a bus line 7.

The CPU 2 that consists of a general processor device controls the operation of the information processing apparatus according to a computer program stored in the ROM 4.

The RAM 3 that consists of volatile semiconductor memory provides work area in which computer programs and processing data that realize processing executed by the CPU 2 are temporarily stored.

The ROM 4 that consists of nonvolatile semiconductor memory comprise a program section 9 in which a boot program (not shown) of the information processing apparatus interface program 8 (described later), and the like are stored and a processing data section 10 in which processing data necessary for executing computer programs is stored. It should be noted that a part or all of computer programs and processing data may be received through electric network.

The display section 5 that consists of a display output device, such as a liquid crystal display or CRT (Cathode Ray Tube) displays on a two-dimensional screen various information such as a three-dimensional object according to a designation from the CPU 2. In other embodiments, a flexible display device made from soft board such as a plastic film may be used as a display section 5.

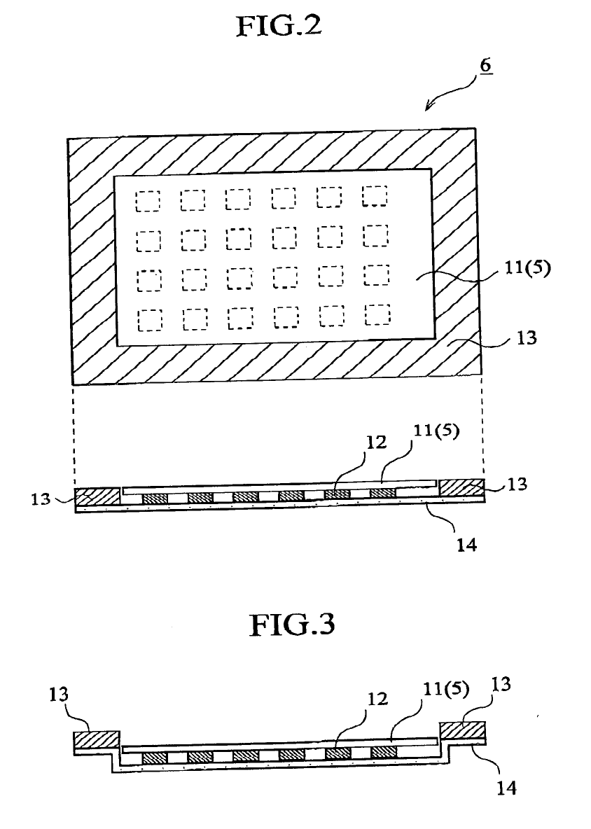

The operation input section 6 consists of a device that is capable of detecting coordinate values (x, y) and a pressing force value P at an arbitrary point on a two-dimensional screen designated by a depression made by a user using his or her hand or a predetermined input device. As shown in FIG. 2 in the first embodiment, the operation input section 6 comprises a touch panel 11 built in or attached to the display section 5, pressure-sensitive elements 12 set up on the back of the touch panel 11, and a back panel 14 supporting the pressure-sensitive elements 12 from backside.

The touch panel 11 detects coordinate values (x, y) of the point on a two-dimensional screen pressed by a user with conventional detecting ways, such as the one using infrared rays, pressure, and electromagnetism. The pressure-sensitive elements 12 detects a pressing force value P on the point on the two-dimensional screen pressed by a user and outputs a pressure detection signal indicating the pressing force value P to the CPU 2. The back panel 14 is fixed to the main apparatus 13 in the way shown in FIGS. 2 and 3.

As described above, in the operation input section 6 according the embodiment of the present invention, a coordinate detector (touch panel 11) and a pressing force value detector (pressure-sensitive elements 12) are positioned on the front and back of the display section 5 respectively. Therefore, it is possible to make the thickness of the display section 5 thinner, compared to the case both the coordinate detector and The pressing force value detector are positioned at the front of the display section 5. As a result the gap that arises between displayed point and a pressed point when a user look at the display section 5 from an oblique angle can be diminished.

When the pressure-sensitive elements 12 are positioned at the front of the display section 5. thin pressure-sensitive elements are usually used to make the display section 5 thinner. However, in case of the above described operation input section 6, since the pressure-sensitive elements 12 are positioned on the back of the display section 5, the degree of freedom for designing can be made larger. For example, the range of the detectable pressing force value P can be made bigger by using the pressure-sensitive elements 12 that have some thickness, the operation input section 6 can be made elastic to some extent and so on. In addition since there is no need to make the pressure-sensitive elements 12 transparent, it is possible to cut down the manufacturing cost of operation input sections by using expensive pressure-sensitive elements.

When a pressure detector positioned at the front of the display section 5, since the display section usually becomes soft, some users feel strange during the operation. However, since the above mentioned configuration makes the surface of the display section 5 soft suitably, users will not feel strange during the operation.

In addition, since the configuration is such that the back panel 14 is connected to the main apparatus 13 and the touch panel 11 is not fixed to the main body 13,it is possible to correctly detect the pressing force value P on the point pressed by a user.

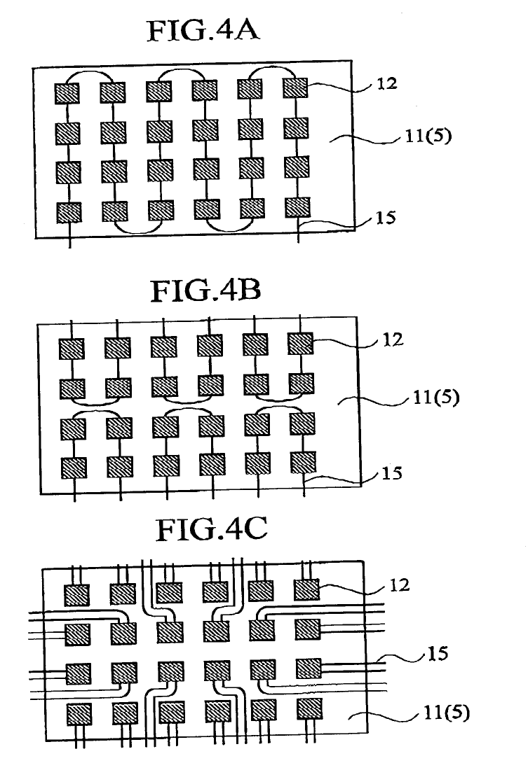

It should be noted that the pressure-sensitive elements 12 may be connected to each other in a row through electric wiring 15, as shown in FIG. 4A and the pressing force value P may be detected all over the touch panel 11. In addition, the pressure-sensitive elements 12 in desired blocks may be connected to each other through electric 15 as shown in FIG. 4B, and the pressing force value P may be detected in every block. Moreover, the respective pressure-sensitive elements 12 may be connected to the electric wiring 15 as shown in FIG. 4C, and the pressing fore value P of the respective pressure-sensitive elements may be detected.

If the user pressing force value P does not match with the pressure detection signal value of the pressure-sensitive elements 12, or if the detection accuracy of a pressing force value P changes depending on the position in a two-dimensional space, it is desirable to correct both values to be the same using an electronic circuit or by software processing. Software processing is preferable for the above correction processing, because the correction processing by software can deal with the changes of correction values due to aging and the differences of average pressing force values due to the differences among users or differences of users' ages.

In the first embodiment of the present invention, the information processing apparatus 1 is configured to detect the coordinate values (x, y) of an arbitrary point on a two-dimensional display screen designated by a user and a pressing force value P separately, using the touch panel 11 and pressure-sensitive elements 12.

Operation of the Information Processing Program

Designation and Selection of a Three-Dimensional Position

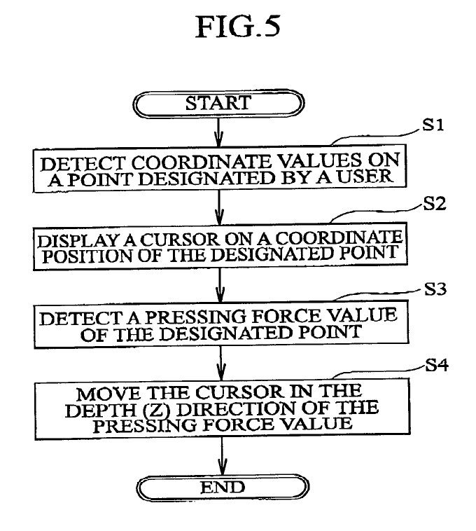

The information processing apparatus 1 having the configuration described above allows users to designate and select an arbitrary three-dimensional position in a three-dimensional space displayed on the display section 5. The operation of the information processing apparatus 1 when a user designates and selects an arbitrary dimensional point in a three-dimensional space will be described below, referring to the flow chart shown in FIG. 5.

The processing in the flow chart shown in FIG. 5 starts when a user w touches a two-dimensional display screen through the touch panel 11 with his or her finger or with a predetermined input device and the CPU 2 executes the following processing according to the interface program 8.

In the processing of step S1, the CPU 2 detects the coordinate values (x, y) of a point 16 on a two-dimensional display screen designated by a user through the touch panel 11 (hereinafter described as designated point 16). Then the processing in the S1 completes and the processing proceeds to step 2.

In the processing of step S2, the CPU 2 controls the display section 5 and displays a cursor 17 on the detected coordinate values (x, y). Then the processing in the step S2 completes and the processing proceeds to step S3.

In the processing of step S3, the CPU 2 detects a pressing force value P at the designated point 16 referring to the pressure detection signal output from the pressure-sensitive elements 12. Then the processing in the step S3 completes and the processing proceeds to step S4.

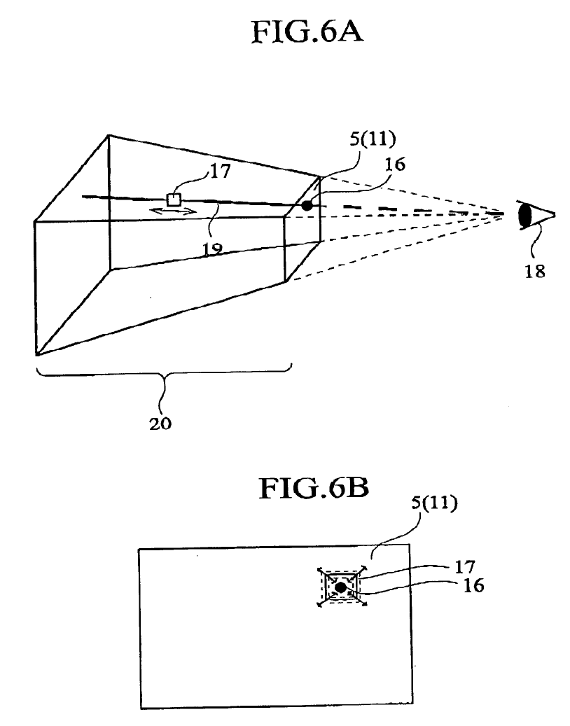

In the processing of step S4, as shown in FIGS. 6A, 6B, the CPU 2 defines a straight line 19 that is parallel to the user's line of sight 18 and extends from the designated point 16 to the depth direction of a rendering area 20 that comprises a three-dimensional space. Then, the CPU 2 moves the cursor 17 by the distance corresponding to the pressing force value P along the straight line 19 in the depth direction. Then, the CPU 2 specifies the position at which the cursor 17 stopped as a three-dimensional position designated by the user in the rendering area 20 by, for example, making the object that exists on the position at which the cursor 17 stopped in a selected state. As a result, the processing in the step S4 completes and a series of designation processing completes.

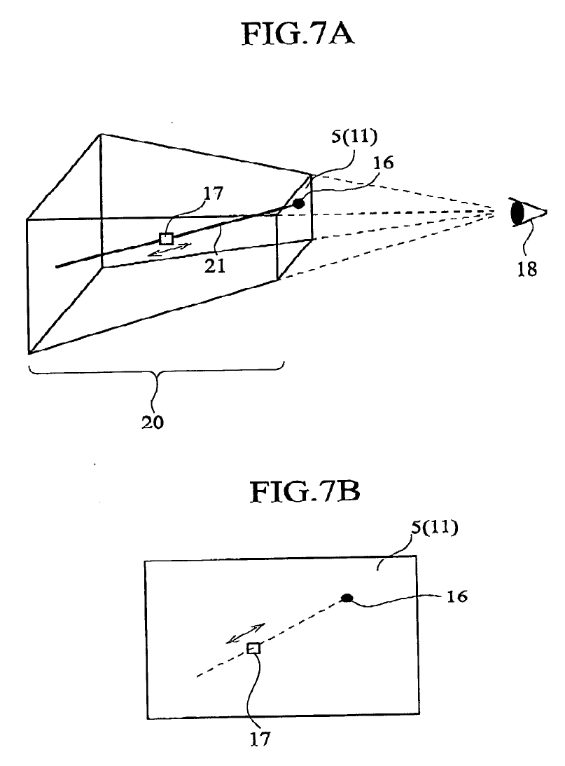

Though the CPU 2 defines the straight line 19 that is parallel to the user'line of sight 18 in the above processing, the CPU 2 may define a and moves the cursor 17 along the straight line 21, as shown in FIGS. 7A, 7B. Such configuration makes it easier for the user to watch the cursor 17 move to the depth direction, compared to the configuration where the straight line 19 that is parallel to the user's line of sight 18 is used. In this case, the CPU 2 may control the display section 5 and display the straight line 19 together with the cursor 17 to let the user know the direction to which the cursor 17 is moving.

In addition, it is desirable that the user can easily see the cursor 17 moving to the depth direction in the rendering area 20 by rendering processing, such as changing the size, color, brightness of the cursor 17, corresponding to the position of cursor 17 in the depth direction, displaying the interference between the object within the three-dimensional space of the rendering area 20 and the cursor 17, displaying grid lines, or forming the rendering area 20 using stereopsis.

Other than the above processing, it is desirable that the user can easily see the cursor 17 moving to the depth direction in the rendering area 20 by processing ,such as vibrating the display screen or producing sound corresponding to the interference between the cursor 17 and the object within the rendering space 20.

As described above, the information processing apparatus 1 detects the pressing force value P on the point on a two-dimensional display screen designated by the user and recognizes the size as a coordinate value (z) in the depth direction. Such processing operation of the information processing apparatus 1 makes it possible to easily designate a three-dimensional position of an arbitrary point in the rendering space 20 of a three-dimensional space by user's designation of a point on a two-dimensional display screen through the touch panel 11. In addition, since the processing operation is close to the actual three-dimensional position designating operation in the real world even users who are not used to device operation can easily designate an arbitrary three-dimensional position within the rendering space 20 without any education or trainings.

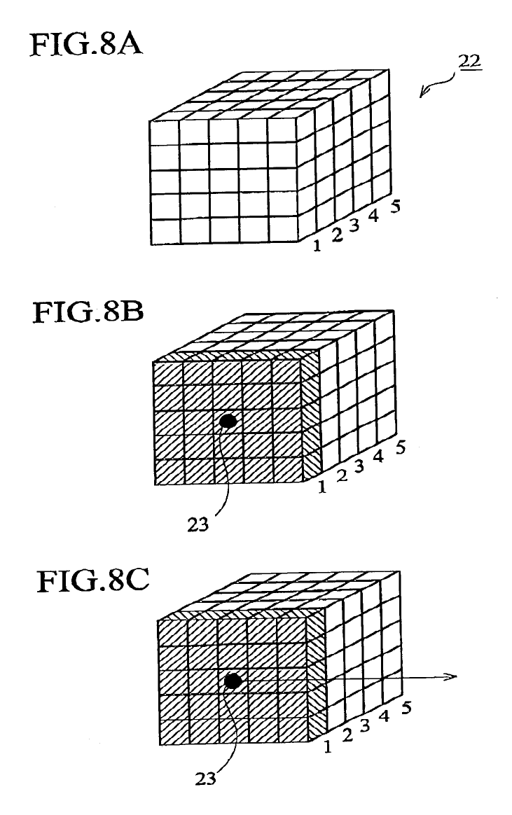

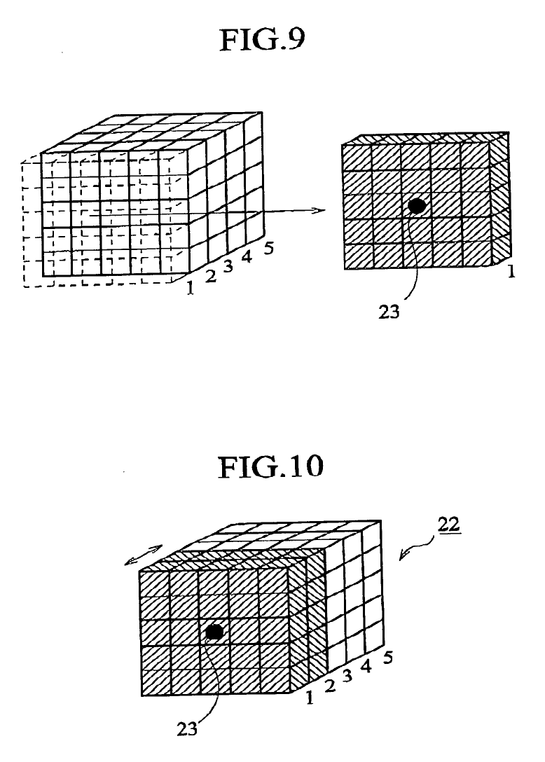

The designating operation of a three-dimensional position as described above is suitable for applying to the operation of objects, such as the one described below. For example, in the case where an object 22 that is configured by arranging five layers of object elements in three-dimensional as shown in FIG. 8A is displayed on the display section 5 and after designating a designated point 23 in the object (FIG. 8B), user can move the object element chosen by the designated point 23 as if to turn a page as shown in FIG. 9 by moving the designated point 23 (FIG. 8C), the user can intuitively change the number of the chosen object elements as shown in FIG. 10 by adjusting the size of the pressing force value P and easily move the desired object element

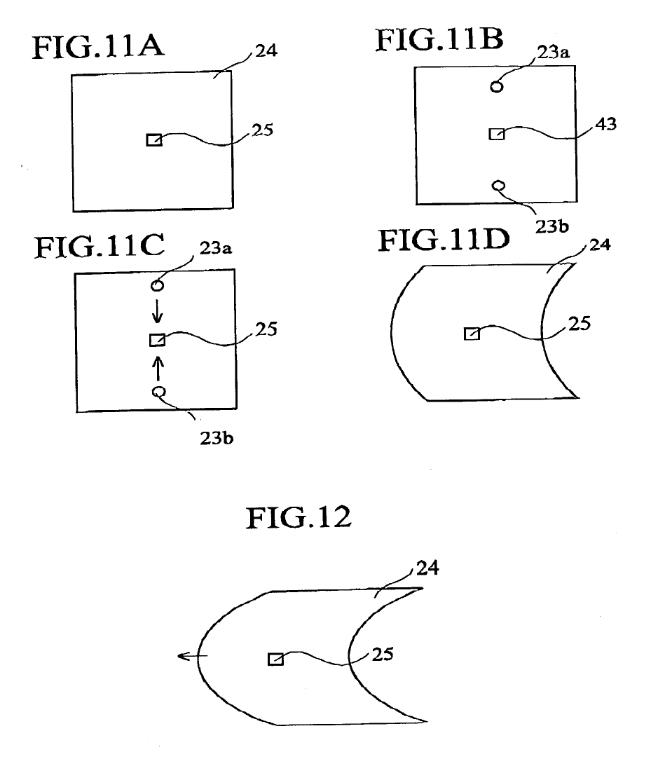

As shown in FIGS. 11A-11C. when a user designates two points 23a, 23b on the touch panel 11 and picks an object 25 arranged on a texture 24 by moving the two points, the user can feel as if he or she actually picked the object 25 in the real world, if the shape of the texture 24 changes according to the pressing force value P as shown in FIGS. 11D, 12.

Operation without a Double-Click

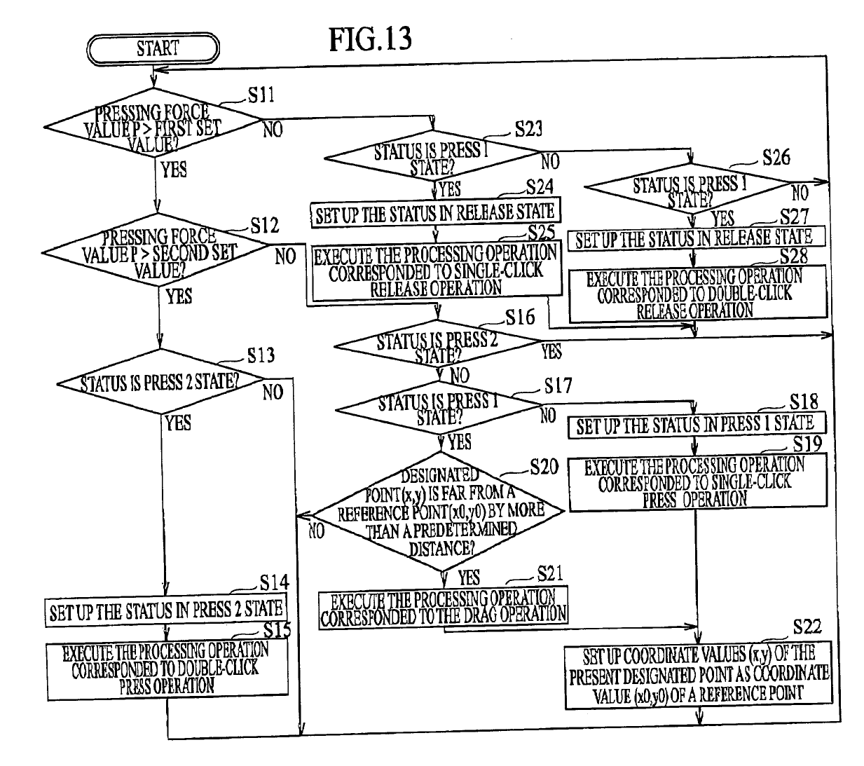

The information processing apparatus 1 configured as described above let users operate an icon representing a folder file or an application program displayed on the display section 5 by natural operation that is close to the operation in the real world without single-click operation or double-click operation that are usually adopted in general computer systems. The processing operation of the information processing apparatus 1 when a user operates an icon will be described in detail next, referring to the flow chart shown in FIG. 13.

The processing shown in the flow chart of FIG. 13 starts when a change of the coordinate values (x, y) and the pressing force value P of a designated point on the touch panel 11 pressed by the user are detected (event detection). The CPU 2 executes the following processing according to the interface program 8.

It should be noted that the CPU 2 stores according to the interface program 8 in the RAM 3 the information related to the coordinate values (x, y) and the pressing force value P that is read at the designated point before the event detection. In addition, the user inputs in advance the first and second set values, P1, P2 (P1<P2) used when the CPU 2 determines which operation of single-click operation or double-click operation has been designated. Then, the CPU 2 stores in the ROM 4 the input values according to the input of the first and second set values P1, P2.

In the processing of step S11, S12, the CPU 2 compares the size of the detected pressing force value P and the first and the second set values P1, P2 that are stored in the ROM 4 and executes processing after classifying processing the cases according to the order of the size as follows.

The operation of the information processing apparatus will be described next using three cases: (i) second set value P2<pressing force value P, (ii) first set value P1<pressing force value P<second set value P2. and (iii) pressing force value P<first set value P1.

In the following processing, the CPU 2 stores in the RAM 3 the last event, so that the CPU 2 can recognizes the states, where, for example, the user is pressing down the designated point with his or her finger or the user is going to move his or her finger off the designated point Then the CPU 2 determines the contents of the detected event by comparing the detected event and the last event and recognizing the change of the state. More specifically, the CPU 2 stores in the RAM 3 three conditions as status: The first set value P1 corresponding to single-click operation is given to the designated point (PRESS 1 state). the second set value P2 corresponding to double-click operation is given to the designated point (PRESS 2 state), and the finger is moving off the designated point (hereinafter described as RELEASE State).

(i) In the Case where the Second Set Value P2<the Pressing Force Value P

In the case where the second set value P2<the pressing force value P, the CPU 2 proceeds to the processing of step S13 from the processing of steps S11, S12. In step S13, the CPU 2 determines whether the status is the PRESS 2 state or not referring to the data within the RAM 3.

If the status turns out to be the PRESS 2 state as a result of the determination processing in step S13, the CPU 2 waits until the next event is detected. On the other hand, if the status does not turn out to be the PRESS 2 state as a result of the determination, the CPU 2 proceeds to the processing of step S14.

In the processing of step S14, the CPU 2 sets up the status in PRESS 2 state and stores the status in the RAM 3. Then, the processing in step S14 completes and the processing proceeds to step S15 from step S14.

In the processing in step S15, the CPU 2 executes the processing corresponding to double-click operation such as activation of an application represented by an icon. Then, the processing for the detected event completes and the CPU 2 waits until the next event is detected.

(ii) In the Case where the First Set Value P1<the Pressing Force Value P<the Second Set Value P2

In the case where the first set value P1<the pressing force value P<the second set value P2, proceeds to the operation processing of step S16 from step S11, S12. In step S16, the CPU 2 determines whether the status is the PRESS 2 state or not, referring to the data within the RAM 3 If the status turns out to be the PRESS 2 state as a result of the determination, the CPU waits until the next event is detected. On the other hand, the status does not turn out to be the PRESS 2 state, the CPU 2 proceeds to the operation processing of step S17.

In the processing of step S17, the CPU 2 determines whether the status is the PRESS 1 state or not, referring to the data within the RAM 3. If the status does not turn out to be the PRESS 1 state as a result of the determination after configuring the status to the PRESS 1 state in the operation processing of step S18, the CPU 2 executes the processing corresponding to single-click operation such as making an application program represented by an icon selected state as the operation processing of step S19. If the processing in step S19 completes, the CPU 2 proceeds to the operation processing of step S22.

On the other hand, if the status turns out to be the PRESS 1 state as a result of the determination processing in step Sl7, the CPU 2 determines whether a designated point (x, y) is far from a reference point (x0, y0) by more than a predetermined distance (DX1, DX2) in step S20. If the designated point turns out not to be far from the reference point by the predetermined distance, the CPU 2 waits until the next event is detected. On the other hand, if the designated point is far from the reference point by more than the predetermined distance, the CPU 2 determines that the detected event is drag operation to move the icon that has been designated by the user with single-click operation and as the processing in step S21, the CPU 2 executes the processing operation to the drag operation. Then, the processing of step S21 completes and the operation processing proceeds to step S22 from step S21.

In the processing of step S22, the CPU 2 stores in the RAM 3 the coordinate values (x, y) of the present designated point as the coordinate values (x0y0) of reference point used in the subsequent processing. Then, the operation processing for the detected event completes and the CPU 2 waits until the next event is detected.

(iii) In the Case Where the Pressing Force Value P<the First Set Value P1

In the case where the pressing force value P<the first set value P1, the CPU 2 proceeds to the operation processing of step S23 from step S11. In step S23, the CPU 2 determines whether the status is PRESS 1 state or not, referring to the data within the RAM 3. If the status tuns out to be the PRESS 1 state as a result of the determination, the CPU 2 determines that the detected event is a movement of taking the finger off after the user single-clicks an icon (herein described as “release motion after single-click operation”). Then, in the processing of step S24, the CPU 2 sets up the status in RELEASE state and in the processing of step S25, the CPU 2 executes the processing corresponding to the “release motion after single-click operation” such as opening folder if the icon is a folder. If the processing in step S25 complete, the CPU 2 returns to the processing of step S11.

On the other hand, if the status out not to be the PRESS 1 state as a result of the determination in step S23, the CPU 2 determines whether the status is PRESS 2 state or not, referring to the data within the RAM 3. If the status turns out to be the PRESS 2 state as a result of the determination, the CPU 2 determines that the detected event is a movement of taking the finger off after the user double-clicks an icon (hereinafter described as “release motion after double-click operation”). Then in the processing of step S27, the CPU 2 sets up the status in RELEASE state and in the processing of step S28, the CPU 2 executes the processing corresponding to the “release motion after double-click operation”. When the processing in step S28 completes, the CPU 2 returns to the processing of step S11 described above. On the other hand, if the CPU 2 determines that the status is not the PRESS 2 state in the processing of step S26, the CPU returns to the processing of step S11 from step S26.

As described above, the information processing apparatus according to the first embodiment determines which of single-click operation and double-click operation is designated referring to the size of the pressing force value on the point designated by a user on a two-dimensional display screen and executes the processing corresponding to the respective operations according to the determination result. Such processing lets users operate an icon displayed on a two-dimensional display screen without troublesome operation such as processing the same point again after taking their finger off the touch panel 11. Therefore, even uses who are not used to the operation of devices can operate an icon easily and naturally. In addition, users can control an icon faster than by double-click operation,because they do not have to take their finger off the touch panel 11.

It should be noted that the above processing can be applied to the operation of slide-type volume control function displayed on the display section 5, though an icon is operated in the above description.

### Second Embodiment

The information processing apparatus according to the second embodiment of the present invention has different configuration and operation of the operation input section 6 from those of the first embodiment. Therefore, only the configuration and operation of the operation input section 6 of the information processing apparatus according to the second embodiment of the present invention will be described in detail next. The description about other components will be omitted because the configuration is the same as the one described above.

Configuration of the Operation Input Section

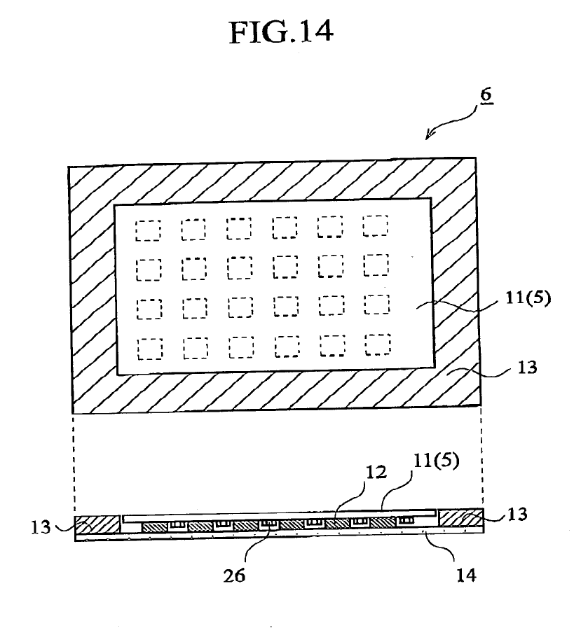

The operation input section 6 according to the second embodiment of the present invention differs from the one according to the first embodiment. As shown in FIG. 14, a plurality of vibration elements 26 are connected on the surface of the touch panel 11 as well as the pressure sensitive elements 12. The vibration elements 26 consists of piezoelectric elements and solenoid etc. and produces vibration corresponding to the operation according to the control from the CPU 2 when a user presses the touch panel 11 for the operation.

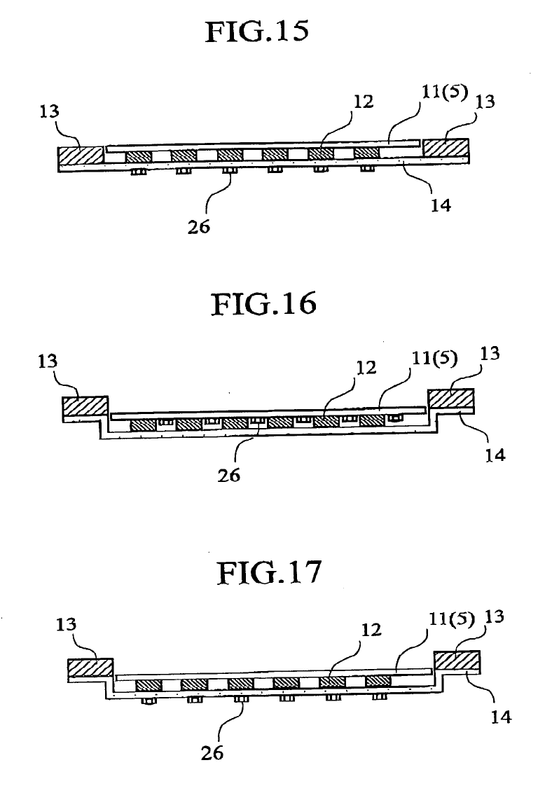

It should be noted that the vibration elements 26 may be connected to the backside of the back panel 14 as shown in FIGS. 15 to 17, though the vibration elements 26 shown FIG. 14 are connected to the surface of the touch panel 11. In addition, the CPU 2 may control the respective vibration elements 26 so that there can be a plurality of vibration patterns.

In addition the vibration pattern of the click vibration produced when a mechanical button is pressed may be stored in the ROM 4 and produced when a user executes a predetermined processing so that the user can feel as if he or she pushed a mechanical button.

Moreover, the size of the produced vibration may be variable according to the change of the pressing force P. In addition, though in the embodiment, a plurality of the vibration elements 26 are provided, only one vibration element may be used to produce vibration if the user touches only one point on the surface of the touch panel 11.

As described above, in the second embodiment, the configuration of the operation input section 6 is such that the vibration elements 26 are added to the operation input section 6 of the first embodiment. As a result the vibration corresponding to the operation can be produced according to the control of the CPU 2 when a user presses the touch panel 11.

Operation of the Information Processing Apparatus

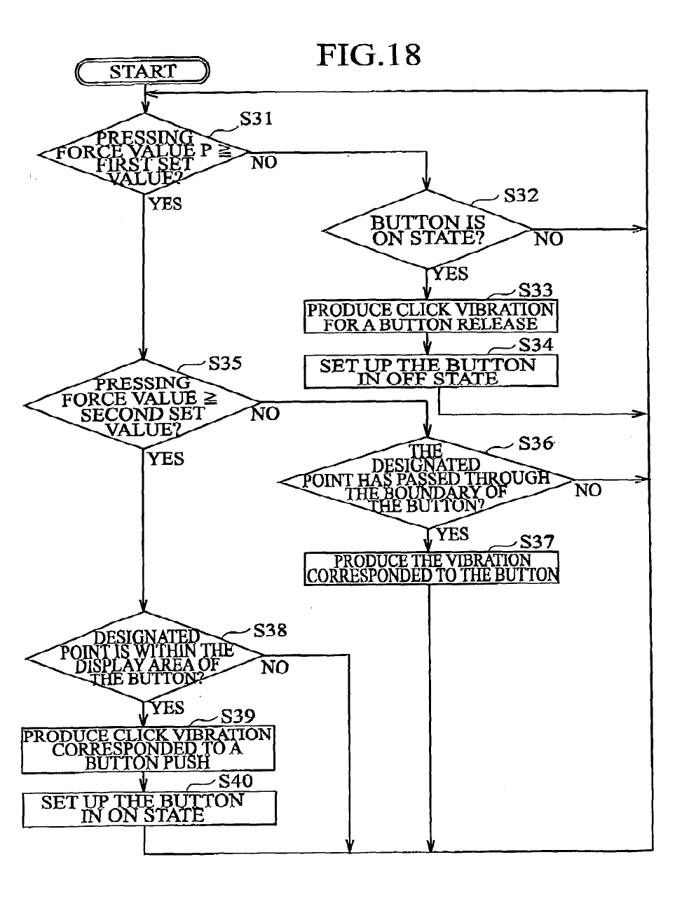

The information processing apparatus having the configuration described above let a user operate an object displayed on a two-dimensional display screen naturally, by executing the processing of the flow chart shown in FIG. 18.

In the following example, the display section 5 displays as an object a button that designates execution of a predetermined processing to the information processing on the screen of the information processing apparatus and a user presses a button displayed on the two-dimensional display screen through the touch panel 11 and makes the button in ON (selected) state, so that the user can designate the process assigned to each button to the information processing apparatus, for example, for opening another window screen.

The processing of the flow chart shown in FIG. 18 starts when the CPU 2 detects the change of the coordinate values (x, y) and the pressing force value P of the point on the touch panel 11 pressed down by the user (event detection) The CPU 2 executes the following processing according to the interface program 8.

In the processing of step S31, the CPU 2 determines whether the pressing force value P is bigger than the first set value P1 or not. The determination processing is for determining whether the user is touching the touch panel 11 or not. After the determination, if the pressing force value P turns out not to be bigger than the first set value P1, the CPU 2 determines whether the button displayed on the two-dimensional screen is in the ON or not in the processing of step S32. The above described set value P1 is set up in advance to the depressing force value detected when the user gives the light touch to the panel 11.

After the determination processing of step S32, if the button turns out to be in the ON state, the CPU 2 determines that the detected event is a movement of taking the finger off after the user presses down the touch panel 11 corresponding to the button. Then in step S33. the CPU 2 produces click vibration for a button release by controlling the vibration elements 26. Then, in step S34, the CPU 2 sets up the button pressed by the user in the OFF state and waits until the next event is detected. On the other hand, after the determination processing in step S32, if the button is not in the ON state, the processing for the detected event completes and the CPU 2 waits until the next event is detected.

On the other hand, after the determination processing in step S31, if the pressing force value P is bigger than the first set value P1, the CPU 2 proceeds to the operation processing of step S35 from step S31. In step S35, the CPU 2 determines whether the pressing force value P is bigger than the second set value P2 (P1<P2) or not. After the determination processing in step S35, if the pressing force value P turns out not to be bigger than the second set value P2, the CPU 2 determines whether the moved point has passed through the position corresponding to a boundary between a button displayed on the two-dimensional screen and the screen or not. It should be noted that the above-noted second set value P2 is set up in advance to the pressing force value detected when the user presses the touch panel 11 with his or her finger.

If the result of the determination processing in step S36 indicates that the moved point has passed through the position corresponding to the boundary, in step S37, the CPU 2 produces the vibration corresponding to the difference in level between the part on which the button is displayed and the part on which the button is not displayed when the moved point passes through the position corresponding to the boundary, so that the user can tell the shape of the button displayed on the two-dimensional display screen. Then, the processing for the detected event completes and the CPU 2 waits until the next event is detected. On the other hand, if the result of the determination processing in step S36 indicates that the designated point has not passed through the position corresponding to the boundary, the processing for the detected event completes and the CPU 2 waits until the next event is detected.

On the other hand, if the result of the determination processing in step S35 indicates that the pressing force value P is bigger than the second set value P2, the CPU 2 proceeds to the operation processing of step Se from step S35. Then, the CPU 2 determines whether the moved point is within the display area of the button displayed on the two-dimensional display screen or not in the processing of step S38. If the result of the determination processing in step S38 indicates that the moved point is within the display area of the button, the CPU 2 determines that the detected event is the movement of pressing the touch panel 11 corresponding to the button and produces click vibration by controlling vibration elements 26 at the moment when the button is pressed in step S39 so that the user can recognize that the button has been pushed. Then, in step S40, the CPU 2 sets up the button pressed by the user in the ON state and waits until the next event is detected. On the other hand, if the result of the determination processing in step S38 indicates that the moved point is not within the display area of the button, the processing for the detected event completes and the CPU 2 waits until the next event is detected.

As described above, the information processing apparatus according to the second embodiment feeds back the sense of touch such as click feeling according to the position of the object, the shape, and the pushing strength, to the user according to the position and pressure on the pressed point on the touch panel 11. Therefore, users can operate an object naturally and the number of operation mistakes can be reduced.

### Other Embodiments

Through the embodiments in which the invention made by the present inventors have been described above, the invention is not limited to the statement and the drawings that are a part of the invention disclosure according to the embodiments.

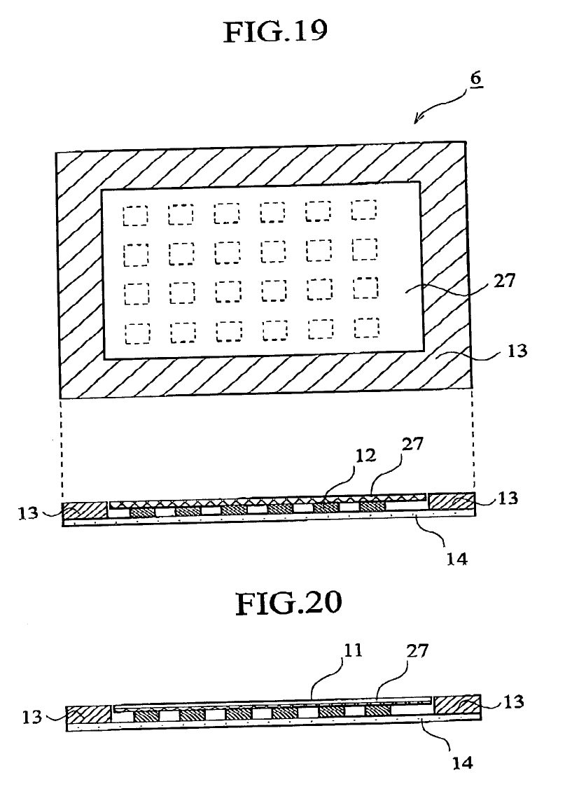

For example, in the information processing apparatus according to the above described embodiments, the touch panel 11 is located within or attached to the display section 5. However, as shown in FIG. 19, a flexible display 27 made from soft boards such as a plastic film may be used as the display section 5. instead of using the touch panel 11 and a plurality of the pressure-sensitive elements 12 may be provided on the back of the display 27.

Since such configuration let the shape of the display section 5 change flexibly according to a user's pressing operation, it becomes possible to detect the value on an arbitrary point pressed by a user more accurately compared to the case where display devices formed by using hard boards such as a liquid crystal display or a CRT device are used as the display section 5.

In addition, above described configuration also makes it possible to detect the pressure value of the respective points when a user presses a plurality of points on a screen at the same time. In this case, it is possible to fix the touch panel 11 to the surface of the flexible display 27 as shown in FIG. 20 and detect the point designated by the user using the touch panel 11 so that the number of the pressure-sensitive elements 12 provided on the back of the flexible display 27 can be reduced. In addition, it is possible that the vibration elements are provided as described in the above embodiment and the sense of the touch is fed back to the user according to the operation when the user touches the flexible display 27.

Moreover, the above described configuration makes it possible to detect the pressing force values of a plurality of points on a two-dimensional display screen in an analog form. Therefore, if the configuration is applied to an operation screen of an electronic musical instrument such as a piano for example, it is possible to create a electronic musical instrument capable of high-grade performance processing by inputting a plurality of sounds. In addition, if the configuration is applied to an operation screen of a video game, it is possible to create game that allows operation performed by both hands and simultaneous operation of every sort of function with a plurality of fingers.

Moreover, since the above described configuration makes it possible to detect the shape of the user'finger or hand that touches a two-dimensional display screen the way of touching the two-dimensional display screen, and the user's movement, completely new operation method based on the shape of a hand or finger movement can be realized, for example, by associating such information with call processing of a predetermined function.

Moreover, since the above described configuration makes it possible to recognize pressure distribution data of the user's operation authentication processing that has never existed before can be realized by extracting the user's characteristics such as the shape of the hand or finger that is touching the two-dimensional screen, pressure distribution, or movement characteristics and by executing authentication processing based on the extracted characteristics.

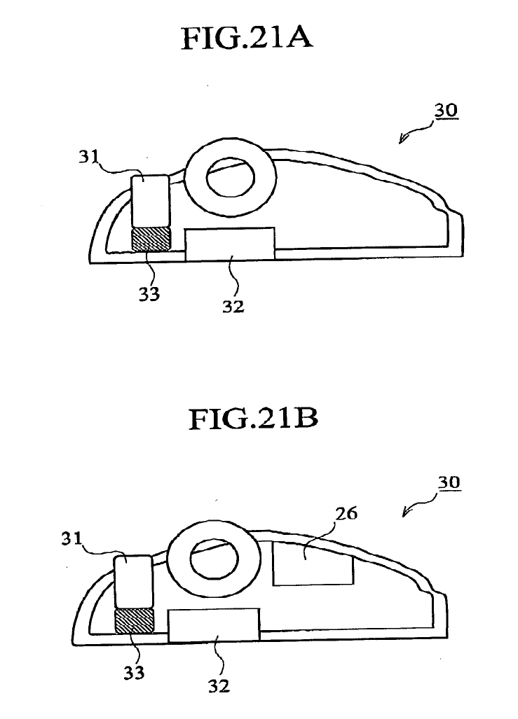

On the other hand, the operation input section 6 may be a mouse pointer 30 shown in FIG. 21A, for example. The mouse pointer 30 shown in FIG. 21A is a general mouse pointer and has a button 31 for switching on and off according to the operation of a user, a detector 32 for detecting a position on a screen designated by the user, and a pressure-sensitive element 33 provided at the bottom of the button 31. The pressure-sensitive element 33 detects a pressing force value when the user operates the button 31 and outputs the pressure detection signal that indicates the size of the pressing force value to the CPU 2. Though the mouse pointer 30 can generally sense only ON/OFF state of the button 31, the mouse pointer 30 according to the configuration shown in the above described FIG. 21A can executes the processing described in the above embodiment according to the size of a pressing force value of the time when the user operates the button 31. In addition, the mouse pointer 30 makes it possible to easily input analog values during various operations such as scrolling, moving, scaling, moving a cursor, and controlling volume etc. by detecting the pressing force value of the time when the user operates the button 31. It should be noted that the vibration element 26 can be provided to the mouse pointer 30 as shown in FIG. 21B and such configuration makes it possible to feed back the sense of touch corresponding to the operation to the user.

In addition, it is possible to calculate a depth value within a three-dimensional space designated by defining pressing force values Pmax, Pmin corresponding to the maximum value and minimum value of a depth value within the three-dimensional space and comparing the pressing force values Pmax, Pmin with the pressing force value P of a designated point.

Moreover, it is also possible to calculate a depth value within a three-dimensional space designated by a user, by making a table in which the relationships between a pressing force value P and a depth value within a three-dimensional space are listed and using the table for retrieving a pressing force value P of a designated point. In this case, the table may be made also by defining an appropriate range (for example, pressing force value P=1 to 3) for the pressing force value P corresponding to a depth value (for example, z=1) according to the position of an object arranged within a three-dimensional space. Such configuration makes the designation operation of a depth value or an object easy, because a depth value corresponding to a pressing force value P is recognized if the pressing force value P of a designated point is within a defined range.

It should be noted that it is also possible to use as a depth value of a designated point a value detected by using a non-contact input device for detecting a distance (distance in depth direction) between an object and the input device is detected using static electricity or by using a camera device (the so-called stereo camera) for detections in which a movement of a user in vertical (depth) direction to a display screen of a display device is detected using a technique of pattern matching and the like, though the information processing apparatus 1 detects and uses the size of a pressing force value P of a designated point as a depth value of the designated point in the above embodiment. In this case, it is desirable that the information processing apparatus 1 changes the depth value of the designated point according to the change of the detected value.

All other embodiments or application made by those skilled in the art based on the embodiment are regarded as part of the present invention.

What is claimed is:

1. An information processing method, compromising the steps of:
displaying a three-dimensional space on a two-dimensional display scrcen;
detecting a coordinate value and a depth value of a point within the two-dimensional display screen designated by a user, and
recognizing a position within three-dimensional space designated by the user according to the coordinate value and the depth value.

2. An information processing method according to claim 1, further comprising the steps of:
displaying a cursor on the point on the point on the two-dimensional display screen designated by the user, and
displaying the cursor that moves in depth direction of the two-dimensional display screen according to a change of the depth value.

3. An information processing method according to claim 2, further comprising the step of:
specifying the position at which the cursor stops as a position within a three-dimensional space designated by the use.

4. An information processing method according to claim 2, further comprising the step of:
changing at least one of size, color, and brightness of the cursor according to the movement of the cursor.

5. An information processing method according to claim 2, further comprising the step of:
executing a predetermined processing according to contact between the cursor and a object within the three dimensional space.

6. An information processing method according to claim 5, wherein:
the predetermined processing is a processing in which at least one of vibration and sound is produced.

7. An information processing method, comprising the steps of:
displaying at least one object on a two-dimensional display screen;
detecting a coordinate value and a depth value of a point on the two-dimensional display screen designated by a user; and
executing processing to the object designated by the coordinate value according to the depth value.

8. An information processing method according to claim 7, further comprising the step of:
selecting the processing by determining whether the depth value is over a predetermined threshold value or not.

9. An information processing method according to claim 7, further comprising the step of:
generating at least one of vibration and sound according to the change of the coordinate values and depth value.

10. A recording medium having recorded therein an information processing program to be executed on a computer, wherein the information processing program comprises the steps of:
displaying a three dimensional space on a two dimensional display screen;
detecting a coordinate value and a depth value of a point within the two-dimensional display screen designated by a user, and
recognizing a position within the three-dimensional space designated by the user according to the coordinate value and the depth value.

11. A recording medium having recorded therein an information processing program according to claim 10, wherein the information processing program further comprises the steps of:
displaying a cursor on the point on the two-dimensional display screen designated by the user, and
displaying the cursor that moves in depth direction of the two-dimensional display screen according to a change of the depth value.

12. A recording medium having recorded therein an information processing program according to claim 11, wherein the information processing program further comprises the steps of:
specifying the position at which the cursor stops as a position within a three-dimensional space designated by the user.

13. A recording medium having recorded therein an information processing program according to claim 11, wherein the information processing program further comprises the step of:
changing at least one of size, color, and brightness of the cursor according to the movement of the cursor.

14. A recording medium having recorded therein an information processing program according to claim 11, wherein the information processing program further comprises the step of:
executing a predetermined processing according to contact between the cursor and a object within the three dimensional space.

15. A recording medium having recorded therein an information processing program according claim 14, wherein
the predetermined processing is a processing in which at least one of vibration and sound is produced.

16. A recording medium having recorded therein an information processing program to be executed on a computer, wherein the information processing program comprises the steps of:
displaying at least one object on a two-dimensional display screen;
detecting a coordinate value and a depth value of a point on the two-dimensional display screen designated by a user, and
executing processing to the object designated by the coordinate value according to the depth value.

17. A recording medium having recorded therein an information processing program according to claim 16, wherein the information processing program further comprises the step of:
selecting the processing by determining whether the depth value is over a predetermined threshold value or not.

18. A recording medium having recorded therein an information processing program according to claim 16, wherein the information processing program further comprises the step of:
generating at least one of vibration and sound according to the change of the coordinate values and depth value.

19. An information processing program to be executed on a computer, comprising the steps of:
displaying a tree-dimensional space on a two-dimensional display screen;
detecting a coordinate value and a depth value of a point within the two-dimensional display screen designated by a user; and
recognizing a position within the three dimensional space designated by the user according to the coordinate value and the depth value.

20. An information processing program to be executed on a computer, comprising the steps of:
displaying at least one object on a two-dimensional display screen:
detecting a coordinate value and a depth value of a point on the two-dimensional display screen designated by a user, and
executing processing to be object designated by the coordinate value according to the depth value.

21. An information processing apparatus, comprising:
a display section for displaying a dimensional space on a two-dimensional display screen;
a coordinate value detector for detecting a coordinate value of a point on the two-dimensional display screen designated by a user;
a depth value detector for detecting depth value of the point on the two-dimensional display screen; and
a controller for recognizing a position witin the three-dimensional space designated by the user according to the detected coordinate value and depth value.

22. An information processing apparatus according to claim 21, wherein
the controller displays a cursor on the point on the two-dimensional display screen and moves the cursor in depth direction to the two-dimensional display screen according to a change of the depth value.

23. An information processing apparatus according to claim 22, wherein
the controller specifies a position at which the cursor stops as a position within a three-dimensional space designated by the user.

24. An information processing apparatus according to claim 22, wherein
the controller changes at least one of size, color, and brightness of the cursor according to the movement of the cursor.

25. An information processing apparatus according to claim 22, wherein
the controller executes predetermined processing according to contact between the cursor and a object within the three dimensional space.

26. An information processing apparatus according to claim 25, wherein the predetermined processing is a processing in which at least one of vibration and sound is produced.

27. An information processing apparatus according to claim 21, wherein
the coordinate value detector and the depth value detector are a touch panel and a pressure-sensitive element respectively.

28. An information processing apparatus, comprising:
a display section for displaying at least one object on a two dimensional display screen;
a coordinate value detector for detecting a coordinate value of a point on the two-dimensional display screen designated by a user;
a depth value for detecting a depth value of the point on the two-dimensional display user; and
a controller for executing processing to the object designated by the coordinate value according to the depth value.

29. An information processing apparatus according to claim 28, wherein
the controller selects the processing by determining whether the depth value is over a predetermined threshold value or not.

30. An information processing apparatus according to claim 28, wherein
the controller generates at least one of vibration and sound according to change of the coordinate values and depth value.

31. An information processing apparatus according to claim 28, wherein
the coordinate value detector and the depth value detector are a touch panel and a pressure-sensitive element respectively.
